(19) United States
(12) Patent Application Publication
(10) Pub. No.: US 2003/0152083 A1
(43) Pub. Date: Aug. 14, 2003

(54) Packet transfer scheduling device and packet transfer scheduling method

(76) Inventors: Nami Nagata, Kawasaki (JP); Yoshinori Tanaka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/284,721

(22) Filed: Oct. 31, 2002

(30) Foreign Application Priority Data
Feb. 1, 2002 (JP) 2002-025663(PAT.P

(51) Int. Cl. H04L 12/56; H04B 7/216

(52) U.S. Cl. 370/395.4; 370/335

(57) ABSTRACT

A packet transmission scheduling device and packet transmission scheduling method with improved required quality for packets, propagation channel quality and throughput, and which, as well as eliminating delays, performs packet transmission with favorable affinity with wireless resources, wherein a plurality of packet flows input in parallel are stored in output standby packet buffers for each of the flows, the output order priority of each packet flow is determined based on any one of the conditions of packet priority, propagation channel quality, allocatable wireless resources are estimated, and estimated allocatable wireless resources are assigned in a wireless resource allocation means to the packet flows stored in buffering means.

### BACKGROUND OF THE INVENTION

1. Field of the Invention

The present invention relates to a packet transfer scheduling device and scheduling method for, in mobile communications that use packet transmissions, using wireless resources limited to various packets of a required quality to transmit with high efficiency.

2. Description of the Related Art

With the spread of Internet access from mobile terminals in recent years, high-speed packet transmission has become an indispensable service in the field of mobile communication, and development of packet transmission technology in a mobile environment is flourishing.

There are various types of information exchanged over the Internet, each of which has their own so-called QoS (Quality of Service) requirements. Meanwhile, the wireless links through which this information passes comprise an extremely unstable environment due to fading, shadowing, and the like, so that a technology for stabilizing and ensuring the required quality of transmission packets is required.

A number of scheduling methods are in use for ensuring QoS on the Internet.

FIG. 20 illustrates a first example of a prior art scheduling method. In FIG. 20, packet flows 1 to M received in bursts are classified in a number of classes (known as QoS classes) 1 to N depending on their required quality by a classifier 201. Here, the required quality of the packets is generally estimated by throughput, delay, and packet loss. The packets classified into their respective QoS classes are buffered in queues 202-1 to 202-N according to their classes. Next, the packets of each queue are sequentially extracted and output to an external link according to an optional queuing method in a queuing section 203.

FIG. 21 illustrates a second example of a prior art scheduling method. In the example of FIG. 21, the packet flows 1 to M are buffered in the queues 211-1 to 211-M for holding the respective queues of the packet flows 1 to M, and the packets of each queue are sequentially extracted according to an optional queuing method and output to an external link in a queuing section 212. A method whereby, in both queuing sections 203 and 212, packets are preferentially output from the queues whose order of priority is highest, and when the queue with highest priority no longer has any packets that need to be output, packets are then output from the queue with the next highest priority, may be utilized. These is known as PQ (priority queuing). When this method is used, although the packet flows with high priority have a reliably ensured bandwidth, those packet flows with lower priority have large delays or, in the worst case, cannot obtain bandwidths at all. Also, in the wireless link, if deterioration occurs in the propagation channel quality due to fading or the like, even if bandwidths are priority allocated, throughput will be reduced because of transmission errors.

FIG. 22 illustrates an example of prior art output queuing. The example of FIG. 22 takes into consideration the state of the wireless link, and is a method wherein, in the queue for each QoS class, only those packets whose propagation channel states are favorable at the time of output are output, but in this case, where the propagation channel state of an output packet is unfavorable and that packet is put in an output queue, any packets following that packet are placed in the output queue even if their transmission states are favorable.

As another queuing method, there are the round robin and WFQ (Weighted Fair Queuing) methods. The round robin method outputs each queue in rotation. The WFQ method outputs packets in rotation in the same way as the round robin method, but allocates the bandwidths of the output link by weighting and separating each packet flow according to its required bandwidth. Although these methods consider fair between packet flows or classes while performing queuing, in either case, instead of there being no packet flows whose bandwidths cannot be ensured as in the PQ methods, in this case the required quality of each packet flow is not reflected in the result.

Also, in both queuing methods, because the output link is assumed to be a wired link, the output packets are time-multiplexed, but in the case of wireless links, output packets are not only time-multiplexed. That is, when scheduling and performing resource allocation with a wired link, bandwidths are allocated by time sharing, but in the case of wireless links, as well as time sharing such as in the TDMA system, bandwidths are allocated according to codes in the CDMA system. However, in prior art scheduling this type of process of allocating bandwidths according to codes has not been considered.

When performing scheduling that reflects the required qualities of individual packets or classes as in the PQ system and the like, impartiality between packets or classes is sacrificed and in the worst case bandwidths are not allocated at all. Conversely, when performing scheduling that takes into consideration impartiality between packets or classes such as in the round robin system, WFQ system and the like, there is the problem of not being able to reflect the required qualities of packets.

Also, in a wireless link, because the quality of the propagation channel changes, the propagation channel quality for the first packets in a high-priority queue is by no means necessarily favorable, therefore transmission errors occur, causing the problem of reduction of throughput, regardless of the priority of bandwidth allocation. Conversely, if packet output awaits recovery of the propagation channel quality, there is the problem of increased delays.

Furthermore, because the packets are output in time sequence after scheduling, there is the problem of unsatisfactory compatibility in wireless resources such as CDMA and the like that are expressed in parameters other than time.

### SUMMARY OF THE INVENTION

In order to solve the above problems of the prior art, the packet transfer scheduling device and packet transfer scheduling method according to the present invention is characterized by comprising buffering means for storing a plurality of packet flows input in parallel in output standby packet buffers for each of the packet flows, output priority determining means for determining the output priority order of each packet flow in overall consideration of packet priority, propagation channel quality and queue length noted by buffer supervising means, wireless resource estimation means for evaluating allocatable wireless resources, and wireless resource allocating means for allocating allocatable wireless resources estimated in the wireless resource estimation means to the packet flows stored in the buffering means.

By providing an output standby buffer for each packet flow, the prior art problem of the lead packet of the buffer being put on transmission standby regardless of the quality of the propagation channel, and thus creating a delay until transmission of the next packet, can be avoided.

Also, transmission priority is not determined conditions such as packet priority, propagation channel quality and the like individually as in prior art scheduling, but estimated in toto from the three conditions of packet priority, propagation channel quality and queue length, therefore the required quality of each packet is reflected therein, and effective wireless resource allocation can be performed according to the propagation channel state, with consideration to impartiality between packets.

Further, unlike the prior art methods of sequential output from the highest priority rank onwards, output priority rankings are determined separately, and because the present invention has a structure wherein allocatable wireless resources are estimated and allocated according to the order of priority, wireless resources with a variety of parameters in all types of access methods can be handled.

Preferably, in the buffering means, each of Equation

$$M \cdot \frac{{m}_{0}}{{\sum }_{i = 0}^{N - 1} {m}_{i}} , M \cdot \frac{{m}_{1}}{{\sum }_{i = 0}^{N - 1} {m}_{i}} , … , M \cdot \frac{{m}_{N - 1}}{{\sum }_{i = 0}^{N - 1} {m}_{i}}$$

among buffering memory regions for packet flow buffering are allocated, where a capacity of buffering memory regions for all input packet flows is M bytes, and transmission speeds for each of the packet flows is m₀, m₁, . . . , m_{(N-1)}.

It is preferable that the output priority determining means is any one of:

a first priority order determining means for firstly determining output priority according to packet priority, determining priority according to propagation channel quality if there are packet flows with the same output priority, and determining priority according to queue length if there are still packet flows with the same output priority;

a second priority order determining means for firstly determining output priority according to propagation channel quality, determining priority according to queue length if there are packet flows with the same output priority, and determining priority according to packet priority if there are still packet flows with the same output priority;

a third output priority determining means for firstly determining output priority according to queue length, determining priority according to packet priority if there are packet flows with the same output priority, and determining priority according to propagation channel quality if there are still packet flows with the same output priority;

a fourth output priority determining means for firstly determining output priority according to packet priority, determining priority according to queue length if there are packet flows with the same output priority, and determining priority according to propagation channel quality if there are still packet flows with the same output priority;

a fifth output priority determining means for firstly determining output priority according to queue length, determining priority according to propagation channel quality if there are packet flows with the same output priority, and determining priority according to packet priority if there are still packet flows with the same output priority; and

a sixth output priority determining means for firstly determining output priority according to propagation channel quality, determining priority according to packet priority if there are packet flows with the same output priority, and determining priority according to queue length if there are still packet flows with the same output priority.

It is further preferable that the output priority determining means determines the output priority order by the first output priority determining means while in a basic state, and while supervising the total throughput of input packet flows and the queue length of each packet flow, uses any one of the first output priority determining means to sixth output priority determining means according to the states of the propagation channel and traffic.

It is still further preferable that the output priority determining means is any one of the first output priority determining means to sixth output priority determining means, and a seventh output priority determining means for firstly determining output priority according to packet priority, determining priority according to propagation channel quality if there are packet flows with the same output priority, temporarily giving a packet flow highest priority if its queue length exceeds a fixed value, and again determining priority according to packet priority and propagation channel quality at the next transmission.

It is still further preferable that the output priority determining means is any one of the first output priority determining means to sixth output priority determining means, and an eighth output priority determining means for assigning each of the conditions of packet priority, propagation channel quality and queue length a fixed point and determining priority by the total number of points of each of said conditions.

It is still further preferable that the wireless resource estimation means makes wireless resources to be allocated to each packet flow applied to a CDMA system into spreading codes, and examines usable spreading codes; and

the wireless resource allocating means allocates spreading codes of a number that satisfies the transmission speed of each packet flow, from the highest priority order determined by the output priority determining means.

It is still further preferable that the wireless resource estimation means estimates a total transmission speed which a maximum total transmission power does not exceed, from a sum total of the transmission power of each packet flow of a previous transmission and a sum total of the transmission speeds of each packet flow, and according thereto estimates allocatable spreading codes.

It is still further preferable that the wireless resource estimation means applies beam forming, the directions of beams thereof differing, and repetitively allocates the same spreading code to all packet flows having sufficiently small interference between the beams.

### BRIEF DESCRIPTION OF THE DRAWINGS

FIG. 1 is a block drawing showing the basic structure of the scheduling device according to a first embodiment of the present invention;

FIG. 2 is a block drawing showing the basic structure of the scheduling device according to a second embodiment of the present invention;

FIG. 3 is a flow chart illustrating the scheduling method according to a third embodiment of the present invention;

FIG. 4 is a flow chart illustrating the scheduling method according to a fourth embodiment of the present invention;

FIG. 5 is a flow chart illustrating the scheduling method according to a fifth embodiment of the present invention;

FIG. 6 is a flow chart illustrating the scheduling method according to a sixth embodiment of the present invention;

FIG. 7 is a flow chart illustrating the scheduling method according to a seventh embodiment of the present invention;

FIG. 8 is a flow chart illustrating the scheduling method according to an eighth embodiment of the present invention;

FIG. 9 is a flow chart illustrating the scheduling method according to a ninth embodiment of the present invention;

FIG. 10 is a flow chart illustrating the scheduling method according to a tenth embodiment of the present invention;

FIG. 11 is a flow chart illustrating the scheduling method according to an eleventh embodiment of the present invention;

FIGS. 12A to 12D are diagrams illustrating how packets are actually allocated according to the order of resource allocation priority determined by each of the above embodiments;

FIG. 13 is a diagram illustrating the Orthogonal Variable Spreading Factor (OVSF) code and hierarchical tree structure in a case where the access method is a CDMA method;

FIG. 14 is a flow chart illustrating the scheduling method according to a twelfth embodiment of the present invention;

FIGS. 15A and 15B are flow charts illustrating the scheduling method according to an example of a thirteenth embodiment of the present invention;

FIGS. 16A and 16B are flow charts illustrating the scheduling method according to another example of the thirteenth embodiment of the present invention;

FIG. 17 is a diagram showing beam forming by a scheduling device according to a fourteenth embodiment of the present invention;

FIG. 18 is a flow chart illustrating part of the scheduling method according to the fourteenth embodiment of the present invention;

FIG. 19 is a flow chart illustrating another part of the scheduling method according to the fourteenth embodiment of the present invention;

FIG. 20 is a diagram for illustrating a first example of a prior art scheduling method;

FIG. 21 is a diagram for illustrating a second example of a prior art scheduling method; and

FIG. 22 is a diagram illustrating an example of an output standby system according to the prior art.

### DESCRIPTION OF THE PREFERRED EMBODIMENTS

Preferred embodiments of the present invention will be explained in detail below, with reference to the accompanying drawings.

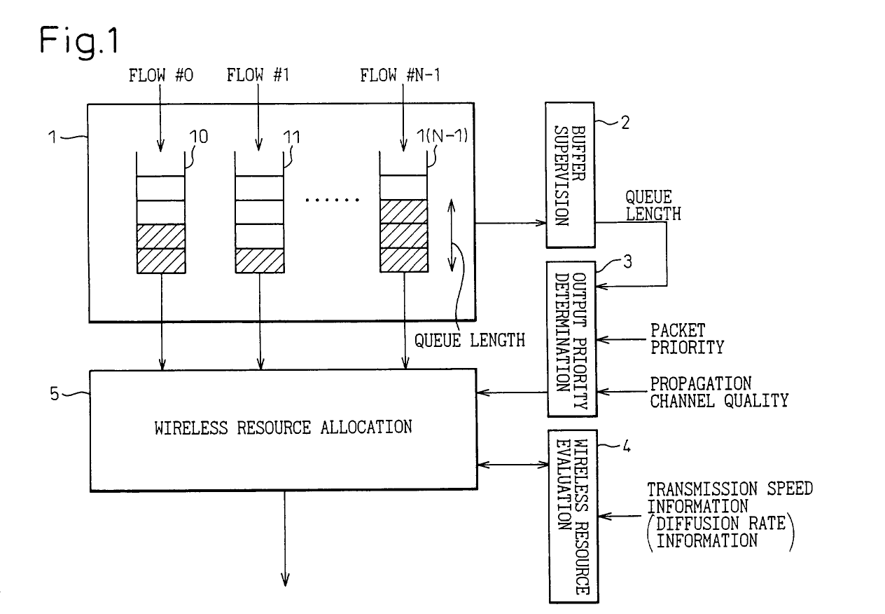

FIG. 1 is a block drawing showing the basic structure of a packet transmission scheduling device according to a first embodiment of the present invention. In the drawing, the scheduling device comprises buffering means 1 for storing a plurality of packet flows #0 to #N−1 input in parallel in output standby packet buffers 10, 11, . . . 1(N−1) for each of the packet flows, output priority determining means 3 for determining the output priority order of each packet flow based on any one of packet priority, propagation channel quality and queue length conditions noted by buffer supervising means 2, wireless resource estimation means 4 for evaluating allocatable wireless resources, and wireless resource allocating means 5 for allocating allocatable wireless resources estimated in the wireless resource estimation means 4 to the packet flows stored in the buffering means.

The plurality of packet flows #0 to #N−1 are input in parallel into the output standby packet buffering means 1 for each packet flow. The buffering means 1 has buffers 10 to 1(N−1) for storing output standby packets for each packet flow. The packets become candidates for sequential output in the order in which they arrive at each of the buffers 10 to 1(N−1). The lengths of the queues in the buffers for each of the packet flows are supervised by the buffer supervising means 2, while the output priority determining means 3 determines the order of priority for when wireless resources are allocated, based on packet priority, propagation channel quality and the queue lengths supervised by the buffer supervising means 2. Packet priority is determined by the required quality of the packets (i.e. throughput, delay, packet redundancy, and the like). For example, the QoS classes regulated by the 3GPP (Third Generation Partnership Project) are as follows.

1) Conversation Class: Voice, VoIP (Voice over Internet Protocol), etc. Requires maintenance of chronological relationships between information blocks and strictly reduced delay times.

2) Streaming Class: Streaming video etc. Maintenance of chronological relationships. Reduced delay times.

3) Interactive Class: Web browsing etc. Requires maintenance of data content in request-response traffic patterns.

4) Background Class: E-mail, database downloads, etc. Data transfer within a given time is not necessary. Maintenance of data content is required.

From the above, the priority of packets within the above classes, for example, could be 1, 2, 3 and 4, from the top downwards.

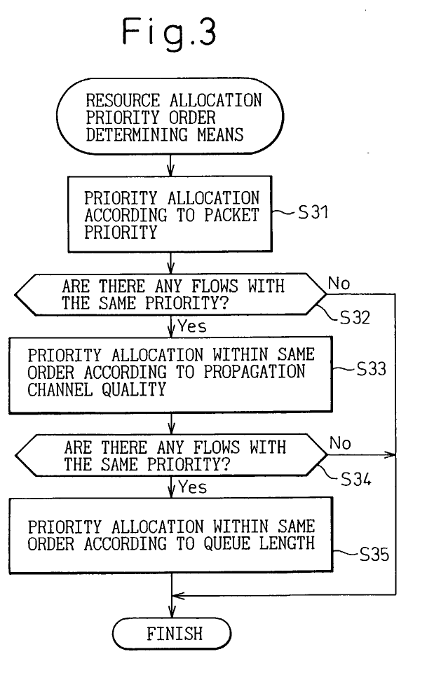

The propagation channel quality may be estimated by measuring the SNR (signal to noise ratio) or SIR (signal to interference ratio) of a directly received signal. Also, where transmission power control is applied, the amount of transmission power is also a criterion. In other words, if the transmission power, standardized by transmission speed, is set low compared to other users', the propagation channel quality can be considered relatively favorable. Similarly, where the AMC (Adaptive Modulation Coding) method is used, the propagation channel state can be estimated by the MCS (Modulation Coding Set) level (consisting of a modulation multivalue and a coding rate). This is because the MCS level is determined according to parameters that indicate the propagation channel state, such as the SIR (signal to interference ratio) of received signals. Also, with regard to packet priority, the higher the packet priority, the higher the priority of resource allocation with regard to propagation channel quality, the packets with the most favorable propagation channel quality receive the highest priority. With regard to queue length, the packets in the packet flows with the longest queue lengths receive the highest priority. From the above viewpoints, the order of priority for resource allocation is determined using one of the algorithms shown in FIG. 3 to FIG. 11, for example.

Currently available wireless resources are estimated in the wireless resource estimation means 4. For example, in a CDMA system, spreading codes are allocated to each user. It is also possible to increase the transmission speed by allocating a number of codes to the same user. Also, the transmission speed can be modified by changing the spreading factor. Codes which are being utilized for other uses (for example, specific control channels, etc.) must be excluded from already-allocated resources.

In the wireless resource allocating means 5, resources are allocated according to the order of priority determined by the output priority determining means 3. Using the example of CDMA as described above, codes are allocated in order from the packets with the highest priority onwards.

The allocated codes are excluded from sequentially allocatable resources in the wireless resource estimation means 4. Thereby, all available codes are allocated. Although those packets with low priority may not be allocated resources, according to circumstances, in such cases, as the queue length of the buffer gradually increases, they are effectively assigned higher priorities by the priority determining means.

By providing output standby buffers for each of the packet flows as in the buffering means 1 of FIG. 1, the prior art problem of the lead packet of the buffer having to await transmission and therefore causing a delay in the transmission of the succeeding packets, regardless of the quality of the propagation channel, as shown in FIG. 21, can be overcome.

Also, rather than determining order of priority at the time of transmission by conditions such as packet priority, propagation channel quality, etc. individually as in prior art scheduling methods, the present embodiment estimates the three conditions of packet priority, propagation channel quality and queue length altogether, therefore, while reflecting the required quality of each packet, and considering impartiality between packets, it can effectively allocate wireless resources depending on the propagation channel state.

Further, unlike the prior art method of sequentially outputting packets starting from the packet with the highest priority, because the present embodiment has a structure wherein output priority is determined separately, and allocatable wireless resources are estimated then allocated according to priority, wireless resources expressed by a variety of parameters in all types of access systems can be handled.

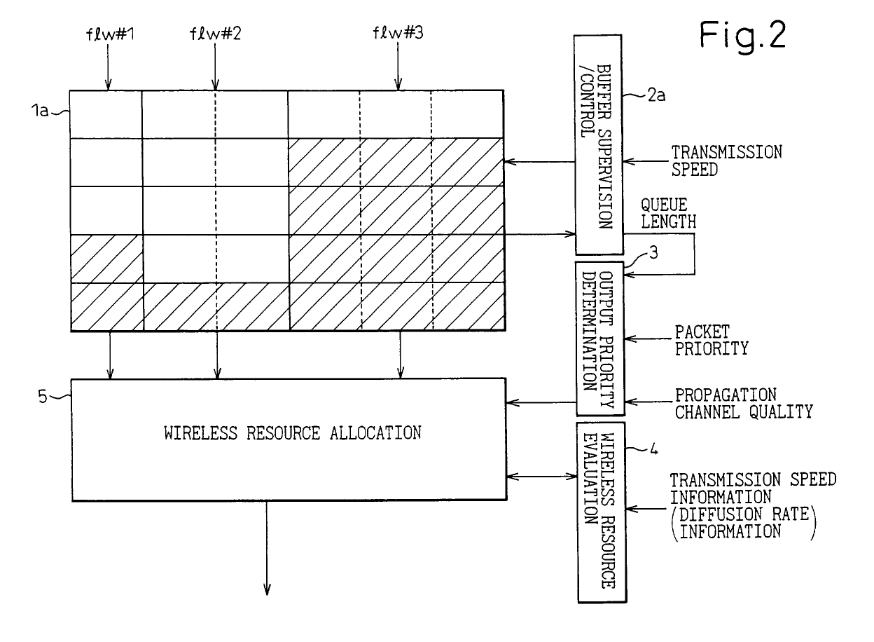

FIG. 2 is a block drawing showing the structure of a packet transmission scheduling device according to a second embodiment of the present invention. In order to simplify explanation, there are only three input packet flows flw#, flw#2 and flw#3, the transmission speeds of each of the packet flows being respectively m, 2m and 3m, 1a is memory regions maintained for buffer use, whose size is M bytes. Reference symbol 2a is buffer supervising/control means for, in addition to supervising the buffers, controlling the buffer allocation regions. At this time the buffer size of each of the packet flows is, respectively, M/6 bytes, M/3 bytes, and M/2 bytes. By allocating buffer sizes according to the transmission speeds of the packet flows in this way, the inefficiencies of overflow quickly occurring in high speed packet flow buffers and continuously unusable regions existing in low speed packet flows, which occur when fixed size buffers are allocated to all packet flows, can be overcome.

Also, buffer supervision can be performed placing the same value the buffer usability (used buffer size per packet flow/total buffer size per packet flow) for each packet flow as on queue length.

FIG. 3 is a flow chart illustrating the operations of a scheduling device according to a third embodiment of the present invention. In the chart, order is determined according to the priority of the packets in step S31, whether there are packet flows having the same order of priority is determined in step S32, and if so, order within the same order of priority is determined according to propagation channel quality in step S33, whether there are packet flows having the same order of priority is again determined in step S34, and if so, order within the same order of priority is determined from those packet flows whose queue lengths are longest, completing the determination process for the order of priority for resource allocation.

In other words, in the present embodiment, the three conditions are estimated with the highest priority being on packet priority, then in the order of propagation channel quality and queue length.

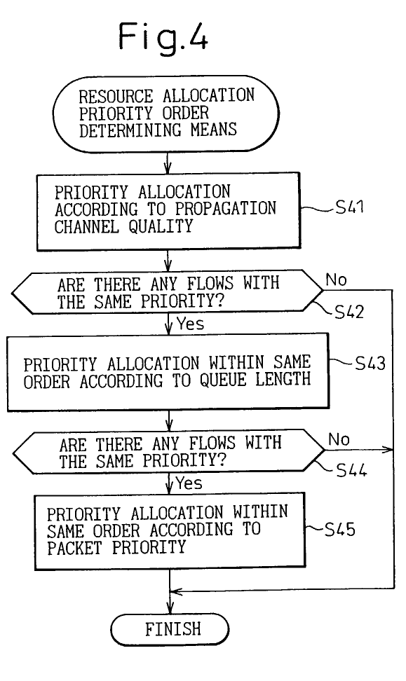

FIG. 4 is a flow chart illustrating the operation of a scheduling device according to a fourth embodiment of the present invention. What differs in FIG. 4 from FIG. 3 is that the order of steps S31, S33 and S35 in FIG. 3 differ in FIG. 4. In other words, in the process of the present embodiment, the three conditions are estimated with propagation channel quality having the highest priority, then queue length and packet priority.

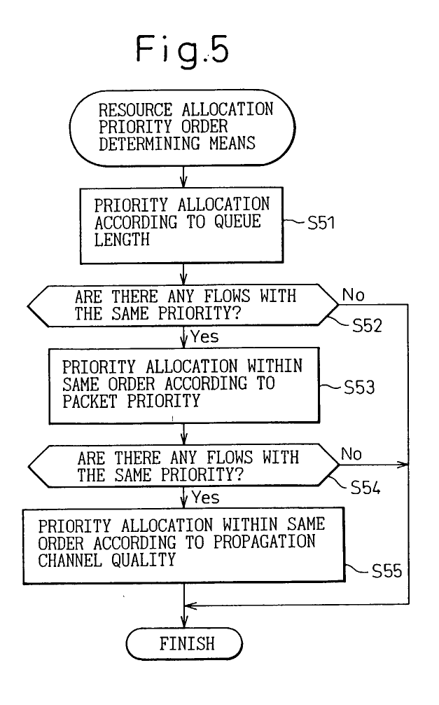

FIG. 5 is a flow chart illustrating the operation of a scheduling device according to a fifth embodiment of the present invention. What differs between FIG. 5 and FIG. 3 is that in this process the three conditions are estimated with queue length having the highest priority, then packet priority and propagation channel quality.

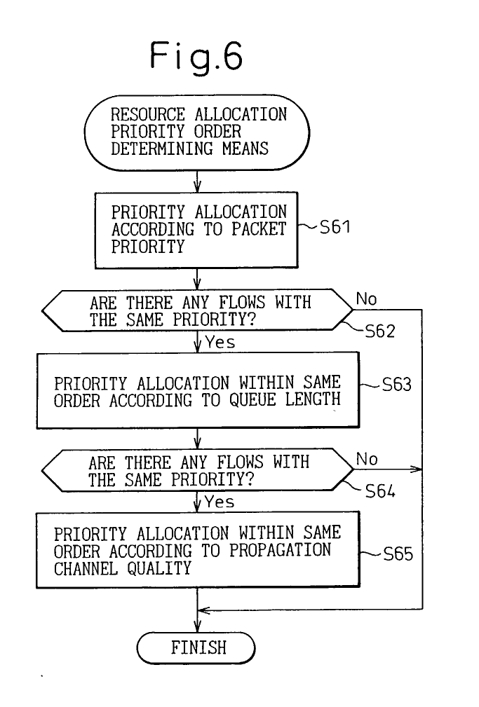

FIG. 6 is a flow chart illustrating the operation of a scheduling device according to a sixth embodiment of the present invention. What differs between FIG. 6 and FIG. 3 is that in this process the three conditions are estimated with packet priority having the highest priority, then queue length, and propagation channel quality.

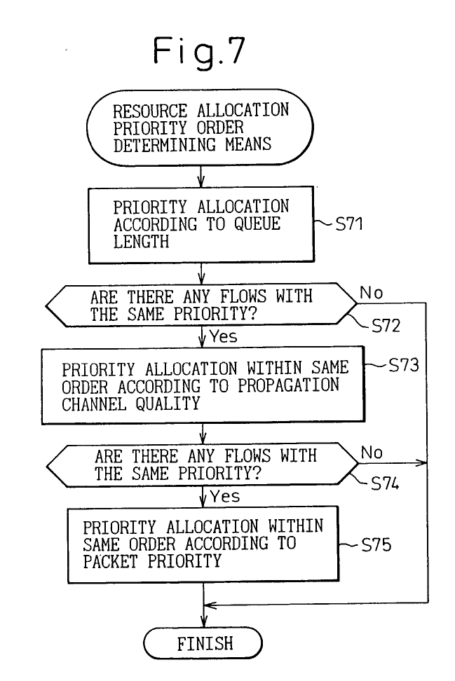

FIG. 7 is a flow chart illustrating the operation of a scheduling device according to a seventh embodiment of the present invention. In FIG. 7, what differs from FIG. 3 is that in this process the three conditions are estimated with queue length having the highest priority, then propagation channel quality, and packet priority.

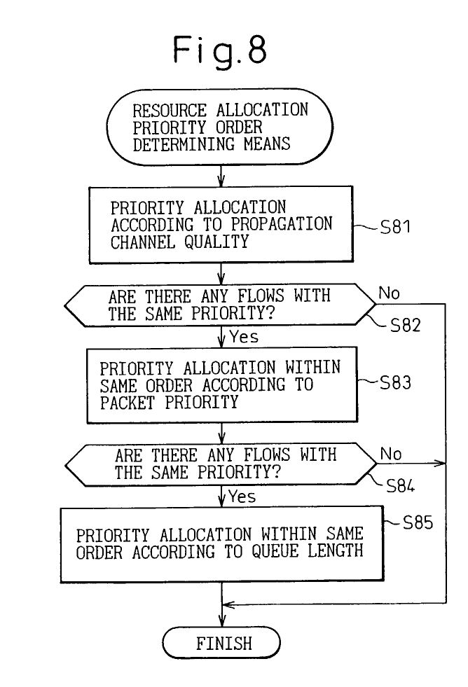

FIG. 8 is a flow chart illustrating the operation of a scheduling device according to an eighth embodiment of the present invention. In FIG. 8, what differs from FIG. 3 is that in this process the three conditions are estimated with propagation channel quality having the highest priority, then packet priority, and finally queue length.

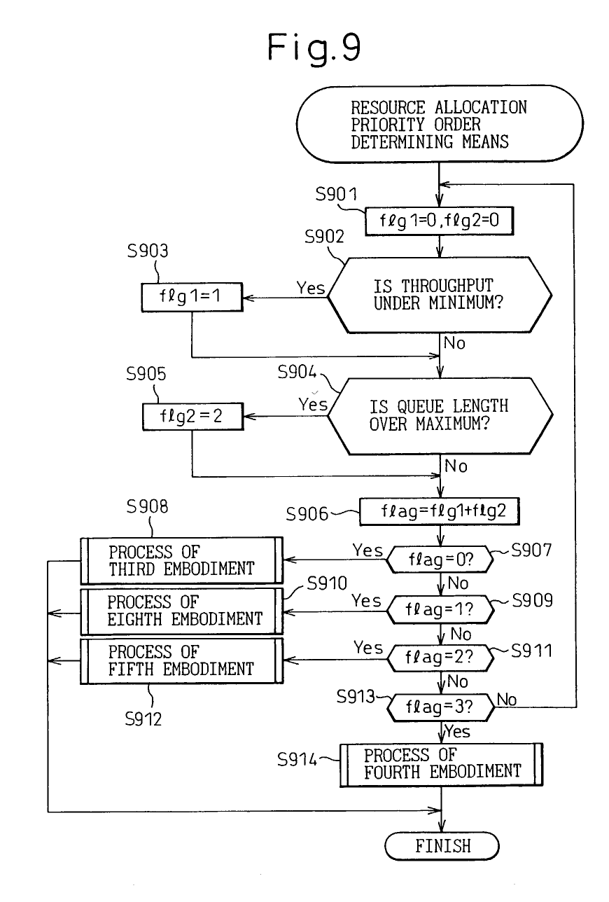

FIG. 9 is a flow chart illustrating the operation of a scheduling device according to a ninth embodiment of the present invention. In FIG. 9, what differs from FIG. 3 is that in this process, in its basic state, the order of priority is determined by the process of the third embodiment. However, the overall throughput of the packet flows is observed in step S902 for each fixed process unit, and if this throughput value falls below a fixed value, a flag 1 is set to 1 in step S903 and the process of the eighth embodiment is executed in step S910.

Also, if the queue length of any of the packet flows exceeds a fixed value in step S904, flag 2 is set to 2 in step S905, and the procedure of the fifth embodiment is executed in step S912.

Further, if the throughput determined in step S902 falls below a fixed value and the queue length determined in step S904 exceeds a fixed value, flag 1 is set to 1, flag 2 is set to 2, and the procedure of the fourth embodiment is executed in step S914.

Here, throughput can be estimated by counting the ACK (or NACK) of each packet with ARQ. If the number of transmission packets within a fixed interval is taken as Np and the number of ACKs as Nack (the number of NACKs being Nnack), the throughput can be taken as Nack/Np (or (1-Nnack)/Np). The present embodiment is a method evaluating propagation channel quality as throughput and traffic as queue length, and selecting the process steps corresponding to each of these states. Thus, each condition is estimated in more detail, and depending thereon, the methods according to the embodiments of FIG. 3 to FIG. 8 can be applied.

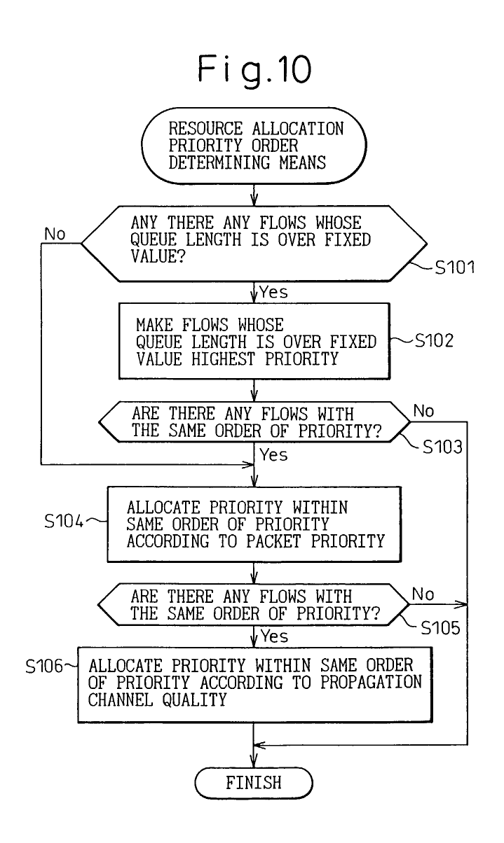

FIG. 10 is a flow chart illustrating the operation of a scheduling device according to a tenth embodiment of the present invention. In FIG. 10, the queue length is observed in step S101 and if there are any packet flows whose queue length exceeds a fixed value, the packets of that packet flow are given the highest priority in step S102, and whether any packet flows have the same order of priority is determined in step S103. If no queue lengths exceed the fixed value in step S101, or if it is determined that there are no packet flows having the same order of priority in step S103, the process proceeds to step S104. In other words, as long as the queue length does not exceed the fixed value, it is not considered at the time of determining the order of priority.

In the subsequent steps S104 to S106, the same processes as in steps S31 to S33 in FIG. 3 are performed. That is, packet priority is estimated with the highest priority, then propagation channel quality.

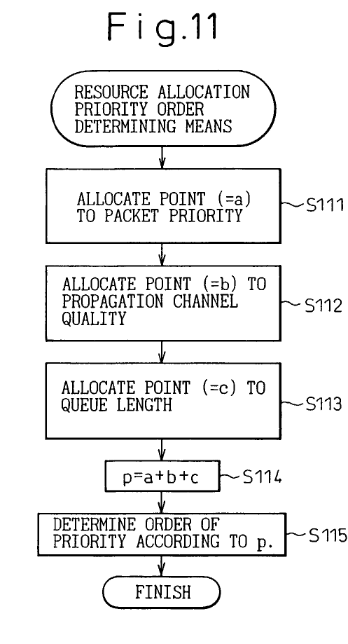

FIG. 11 is a flow chart illustrating the operation of a scheduling device according to an eleventh embodiment of the present invention. In FIG. 11, an estimation point a is given to the packet priority in step S111, an estimation point b is given to the packet priority in step S112, and an estimation point c is given to the packet priority in step S113. Next, a total sum value p of the estimation points is calculated in step S114. Then, in step S115, the highest priority is given from the packet flow whose total point value p of the three conditions is highest. An example of this point allocation is shown in Table 1.

### Table 1 Example of Point Allocation in Eleventh Embodiment

### Example of Point Allocation for Packet Priority

(a)

| Estimation | Priority | Priority | Priority | Priority | Priority |
|---|---|---|---|---|---|
| Standard | 1 | 2 | 3 | 4 | 5 |
| Points | 5 | 4 | 3 | 2 | 1 |

### Example of Point Allocation for Propagation Channel Quality

(b)

| Estimation | | | |
|---|---|---|---|
| Standard | SIR > SIRmax | SIRmax > SIR > SIRmin | SIRmin > SIR |
| Points | 5 | 3 | 1 |

SIRmax, SIRmin set specific value

### Example of Point Allocation for Queue Length

(c)

| Estimation | | | |
|---|---|---|---|
| Standard | L > Kmax | Lmax > L > Lmin | Lmin > L |
| Points | 5 | 3 | 1 |

Lmax, Lmin set specific value

Table 1(a) shows an example of the point allocation for packet priority of step S111. In this case higher points are simply allocated to packet flows with higher priority estimation standards.

Table 1(b) shows an example of the point allocation for packet priority of step S112. In this case, point b is 5 when the signal to interference ratio SIR is SIR>SIRmax, point b is 3 when the SIRmax>SIR>SIRmin, and point b is 1 when SIRmin>SIR.

Table 1(c) shows an example of the point allocation of packet priority of step S113. In this case, point c is when the queue length L is L>Lmax, point c is 3 when Lmax>L>Lmin, and point c is 1 when Lmin>L.

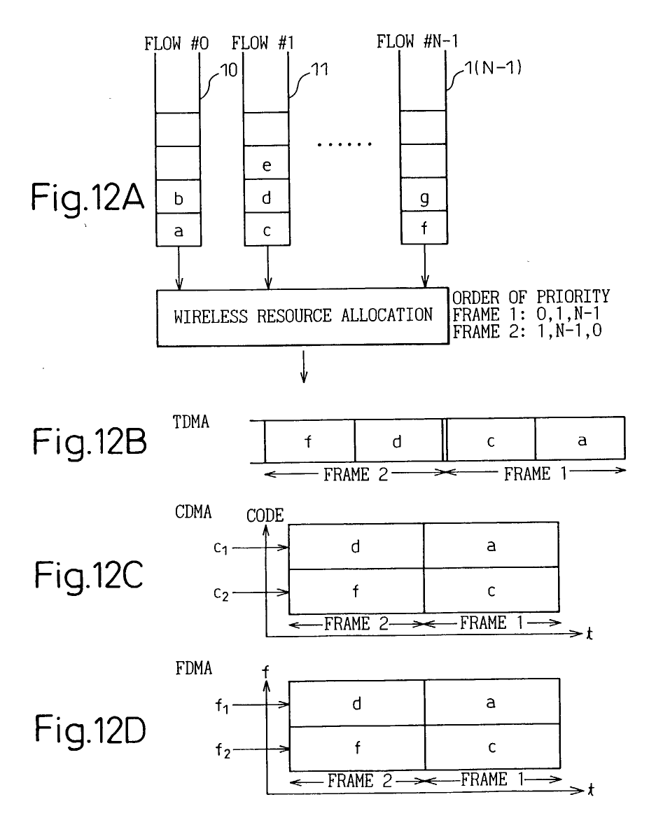

FIG. 12A to FIG. 12D are diagrams illustrating how packets are actually allocated according to the order of resource allocation priority determined by each of the above embodiments.

In FIG. 12A, packets a, b, are stored in the buffer 10 of the packet flow #0 in the order shown, packets c, d, e, . . . are stored in the buffer 11 of the packet flow #buffering means 1 in the order shown, and packets f, g, are stored in the buffer 1(N−1) of the packet flow #1(N−1).

Also, the resource allocation order of priority set as above is such that the packet flow in frame 1 is #0, #1 and #N−1, and in frame 2 is #1, #n−1 and #0.

Thus, as shown in FIG. 12B, where the number of available slots is two slots per frame in the case of TDMA (Time Division Multiple Access), in frame 1 packets a and c are allocated according to the order of priority. Since there are only two slots per frame, the lead packet f of the third frame #N−1 in order of priority cannot be allocated to frame 1. Similarly, according to the order of priority packets d and f can be allocated to frame 2.

As shown in FIG. 12C, where the number of available codes is two codes per frame in the case of CDMA (Code Division Multiple Access), in frame 1 packet a is allocated to C₁, and packet c is allocated to code C₂. In frame 2, packet d is allocated to code C₁ and packet f is allocated to code C₂.

As shown FIG. 12D, where the number of available frequencies is two per frame in the case of FDMA (Frequency Division Multiple Access), in frame 1 packet a is allocated to frequency f₁, and packet c is allocated to frequency f₂.

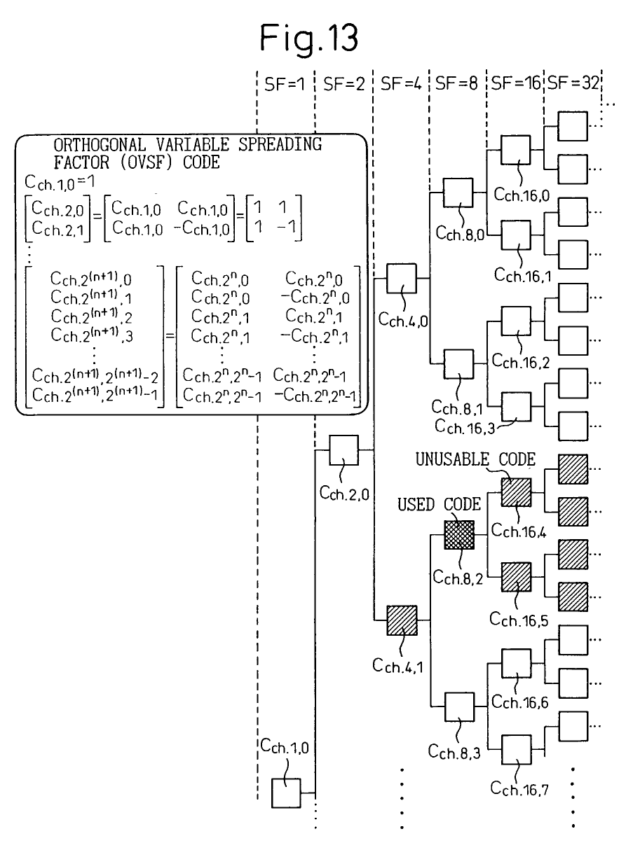

FIG. 13 is a diagram illustrating the orthogonal Variable Spreading Factor (OVSF) code and hierarchical tree structure in a case where the access method is a CDMA method.

The OVSF code, as shown in FIG. 13, can recurrently construct a code with a SF (Spreading Factor) of 2ⁿ (N is arbitrary), and can multiply all the signals that utilize codes of differing spreading factors, except codes of the same series.

In further detail, where SF=1, there is only one allocatable code (Cch_{1,0}) per frame, where SF=2, there are two allocatable codes (Cch_{2,0} and Cch_{2,1} (not shown)) per frame, and where SF=4, there are four allocatable codes (Cch_{4,0}, Cch_{4,1}, Cch_{4,3} (not shown) and Cch_{4,4} (not shown)) per frame, etc.

The determinant shown on the left side of FIG. 13 illustrate the recurrent structure of the OVSF codes. In this determinant, the code of SF=1 is C_{ch1,0}1, and the codes of SF=2, C_{ch2,0} and C_{ch2},1, are determined such that they are orthogonal code using the code of the previous stage SF=1, etc.

Since the SIR deteriorates if codes of the same spreading factor and codes of the same series are used within the same frame, they cannot be used. For example, in FIG. 13 if the code CH_{ch8,2} Of SF=8, indicated by cross-hatching, is already used, the codes CH_{ch4,1}, CH_{ch16,4}, Ch_{ch16,5} etc. indicated by diagonal shading and belonging to the same series cannot be used.

Where the spreading factor is 2, one-bit data is diffused to two bits and sent. Where the spreading factor is 4, one-bit data is diffused to four bits and sent. Consequently, the transmittable data amount per frame does not increase as much as the spreading factor.

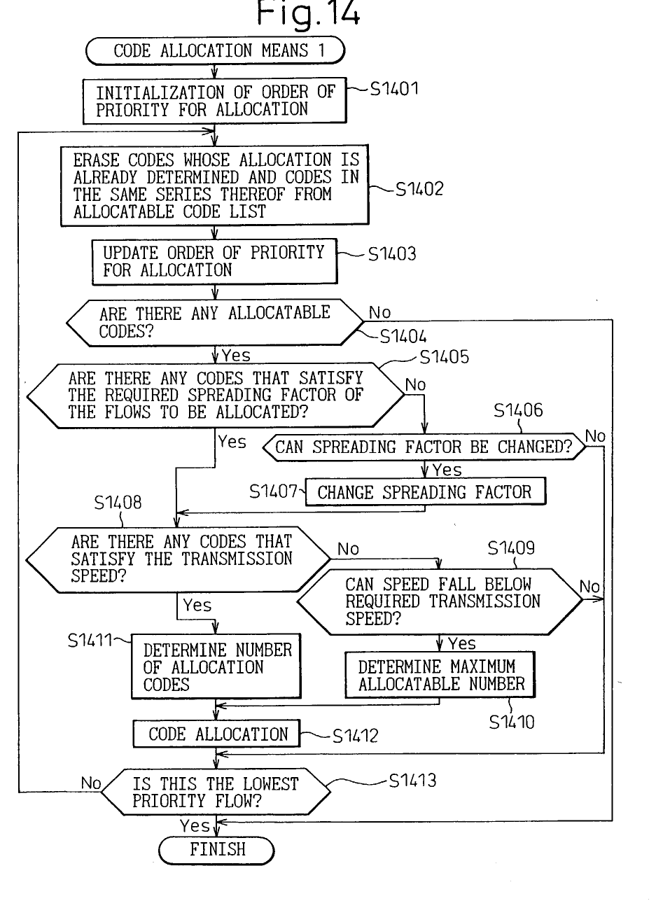

FIG. 14 is a flow chart illustrating the wireless resource estimating means 4 in the scheduling device and the resource estimation and allocation method within the wireless resource estimating means, according to a twelfth embodiment of the present invention. In the CDMA system, resources (zones) are allocated using codes. For example, a case using the OVSF codes shown in FIG. 13 will be explained.

In FIG. 14, in step S1401 the order of priority for allocation in the allocation list within the wireless resource estimating means 4 is initialized, and in step S1402, in the wireless resource estimating means 4 of FIG. 1, those codes whose allocation has already been determined are subjected to removal from the list of allocation candidates and codes from the series as the already allocated codes are also removed (refer to the cross-hatched code and the diagonally shaded codes in FIG. 13).

Next, in step S1403, the order of priority for allocation in the wireless resource estimating means 4 is updated. In other words, in this step, the already allocated flows are removed from those to be allocated.

In the next step S1404, whether there are any allocatable codes in the code list in the wireless resource estimating means wireless resource estimating means 4 is determined, and if they do exist, the process proceeds to step S1405, where it is determined whether there are any codes in the code list of the wireless resource estimating means 4 that satisfy the required spreading factor of the packet flows for allocation.

If it is determined that there is no result in step S1405, the process proceeds to step S1406 where it is determined whether the spreading factor can be changed, and if so, the spreading factor is changed in step S1407. Whether the spreading factor can be changed is determined by the design of the system, for example, there are cases where whether the spreading factor can be changed is dependent on the state of the propagation channel and traffic.

After step S1407, or if the answer to step S1405 is yes, the process proceeds to step S1408, where it is determined whether only the number of codes that satisfy the transmission speed are left in the code list in the wireless resource estimating means 4.

If the result determined in step S1408 is no, in step S1409 it is determined whether the wireless resource estimating means 4 can fall below the required transmission speed. If the answer to this is yes, the maximum allocatable number is determined in step S1410.

If the determination of step S1408 is yes, the number of allocation codes is determined in step S1411.

After step S1410 or step S1411, in step S1412 codes are allocated in the wireless resource allocating means 5, and whether all flows have been checked is determined in step S1413. If the result of this determination is no, the process returns to step S1402 and repeats itself.

If it is determined in step S1404 that there are no allocatable codes, the process finishes.

In the above manner, in the wireless resource allocating means 5, the resources (codes) estimated by the wireless resource estimating means 4 according to the order of priority determined by the output priority determining means 3 are allocated. A spreading factor corresponding to the required transmission speed of each packet can also be selected. For example, a code with a small spreading factor can be allocated to a high speed packet, or a code with a large spreading factor can be allocated to a low speed packet. Also, the number of codes allocated can be determined by a number corresponding to transmission speed. The codes allocated in consideration of the above are noted in the wireless resource estimating means 4 as used codes and removed from the list of candidates for allocation in the wireless resource estimating means 4. In this way, 1) used codes are erased from the wireless resource estimating means 4, and 2) determination of allocation candidate codes in the wireless resource estimating means 4, 3) code allocation in the wireless resource allocating means 5, and 4) notification to the wireless resource estimating means 4 of allocation codes in the wireless resource allocating means 5 are repeated until there are no more allocation codes.

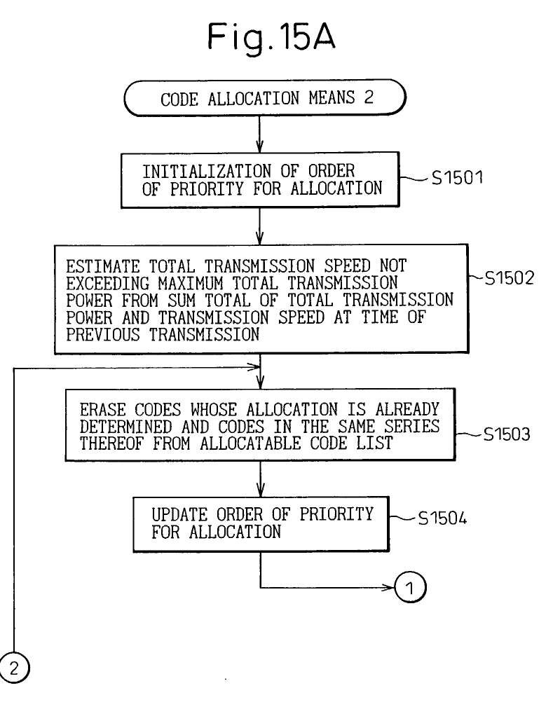

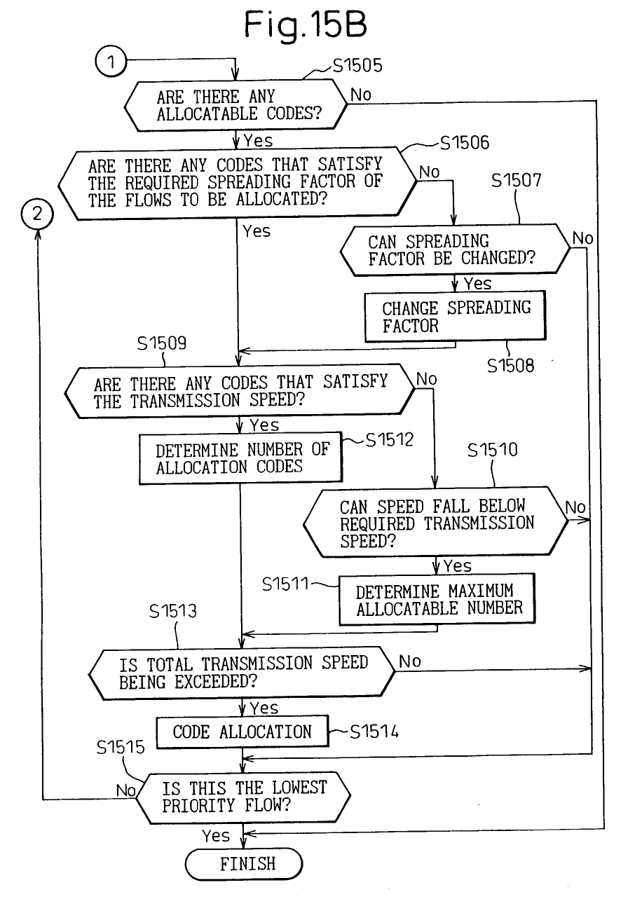

FIGS. 15A and 15B are flow charts illustrating the code allocation process in the scheduling device according to a first example of the thirteenth embodiment of the present invention. The difference between FIGS. 15A and 15B and FIG. 14 is the addition in FIG. 15A of a step S1502 of estimating a total transmission speed not exceeding a maximum total transmission power calculated from the sum total of the transmission power and transmission speed at the time of the previous transmission, in step S1502.

In other words, in the scheduling method shown in FIG. 14, a total transmission speed not exceeding a maximum total transmission power calculated from the sum total of the transmission power and transmission speed at the time of the previous transmission is estimated by the wireless resource estimating means 4 of FIG. 1, and code allocation is performed within the range not exceeding this total transmission speed. If the required total transmission speed is given as R, and the previous transmission speed, total transmission power, and maximum total transmission power are given as Rₗₐₛₜ, Pₗₐₛₜ, and Pₘₐₓ respectively, then

R=(Pₘₐₓ/Pₗₐₛₜ)·Rₗₐₛₜ

Also, before point 1) of erasing used codes in the code allocation process of FIG. 14 described above, a point 1)′ of estimating an allocatable transmission speed (total transmission power) is added. However, where a TPC (Transmission Power Control) is applied, transmission speed cannot be simply estimated.

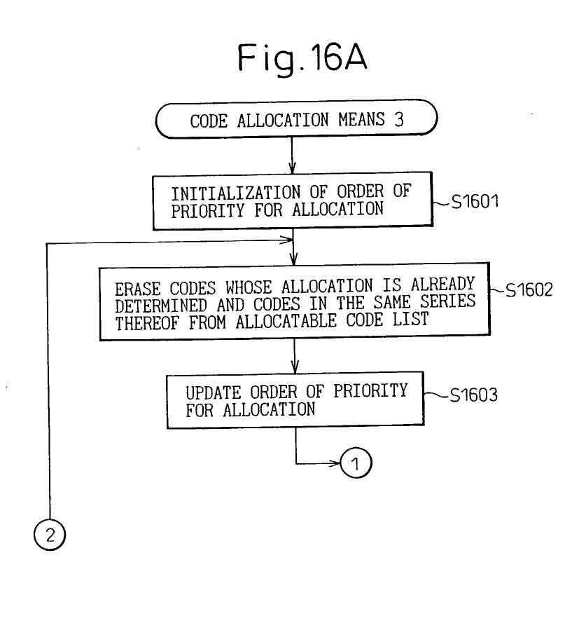

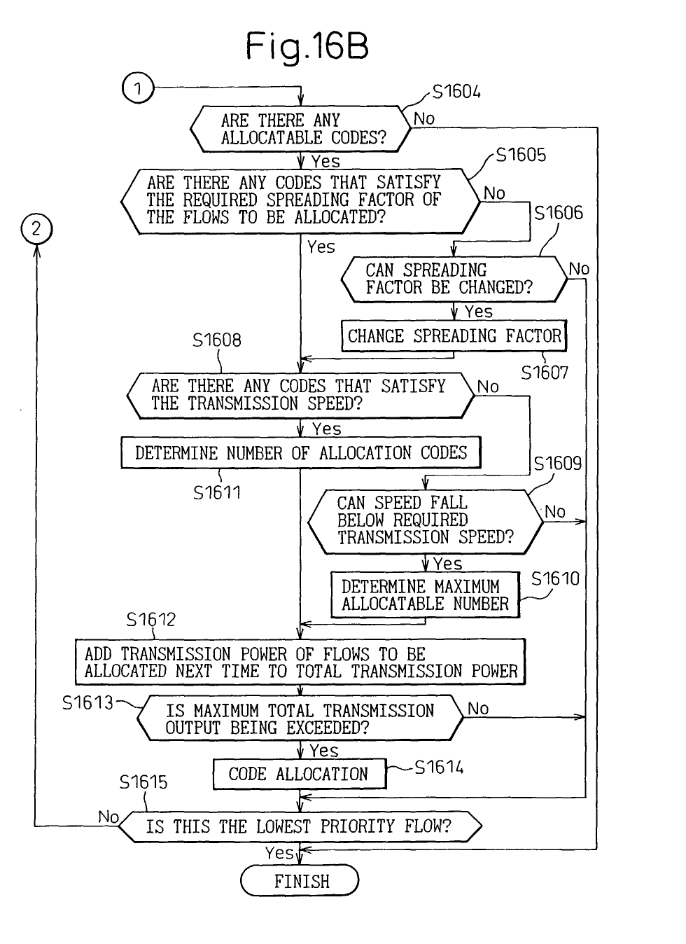

FIGS. 16A and 16B are flow charts illustrating the code allocation process in the scheduling device according to a second example of the thirteenth embodiment of the present invention. The difference between FIGS. 16A and 16B and FIG. 14 is the addition in FIG. 16A of step S1612 where direct transmission power is calculated, and step S1613 where it is determined whether the calculated transmission power exceeds a maximum transmission power. In this way, by controlling allocation resources so that the total transmission power does not exceed the maximum total transmission power, increases in interference between codes and between cells due to excess allocation of resources can be prevented.

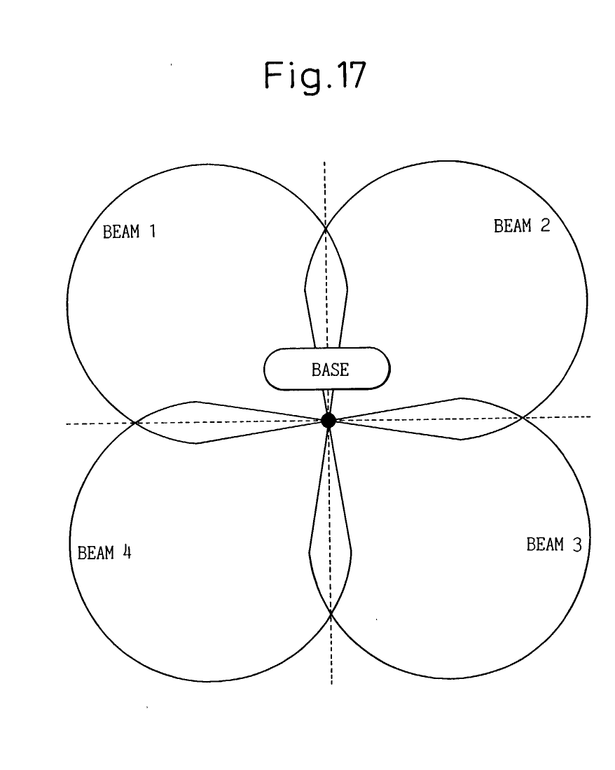

FIG. 17 is a diagram illustrating beam forming by the scheduling device according to a fourteenth embodiment of the present invention.

In the present embodiment, downlink beam forming is applied to the scheduling method of FIG. 14. Downlink beam forming generates a directivity pattern for the downlink based on a direction of arrival (DOA) estimated result performed during an uplink, and performs directivity beam transmission. Since interference due to beam overlap and side lobes can be reduced a method of placing a fixed gap between beams and applying a different scrambling code to each beam, etc., it is possible to perform allocation with all beams below a fixed level of interference and repetitively with the same codes or codes in the same series.

For the sake of simplicity, it is assumed for example that the region covered by one base is shared by four beams, as shown in FIG. 17, and a method of performing code allocation within this assumption will be explained. Interference between beam 1 and beam 3 is sufficiently low. Also, interference between beam 2 and beam 4 is similarly sufficiently low. As a method for reducing interference, as described above, a method of sufficiently opening the gap between beams, and a method of using a scrambling code for beam selection, etc. can be considered. At this time, the same code or code from the same series can be repetitively allocated to the terminal in beam 1 and the terminal in beam 3. Similarly, the same code or code from the same series can be repetitively allocated to the terminal in beam 2 and the terminal in beam 4.

Firstly, with an allocatable code list for each beam, the order of priority for all of the packets transmitted to the terminals within the cells is determined. Then, codes are allocated according to the order of priority. For example, where the code C1 from an allocatable code list for beam 1 is allocated to the packet to be sent to the terminal in beam 1, C1 from all of the allocatable code lists for beam 1, beam 2 and beam 4 and codes from the same series are erased. Further, where a code C2 is allocated to a packet of the terminal in beam 2 according to the order of priority, the process of removing C2 and codes from the same series from the allocatable code lists for beam 1, beam 2 and beam 3 is repeated, until all codes in the allocatable code list are allocated. Naturally C1 and codes from the same series as C1 are allocatable to packets to the terminal in beam 3, and C2 and codes from the same series as C2 are allocatable to packets to the terminal in beam 4. In addition, the embodiments of FIG. 15 or FIG. 13 can be applied to each of the beams, the allocated codes controlled, and increase in interference prevented.

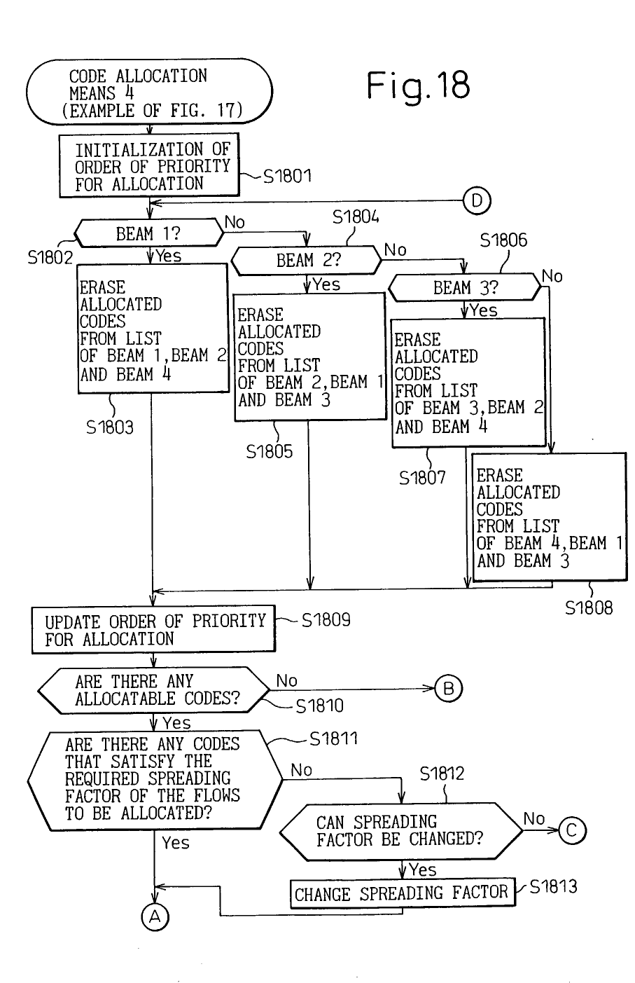

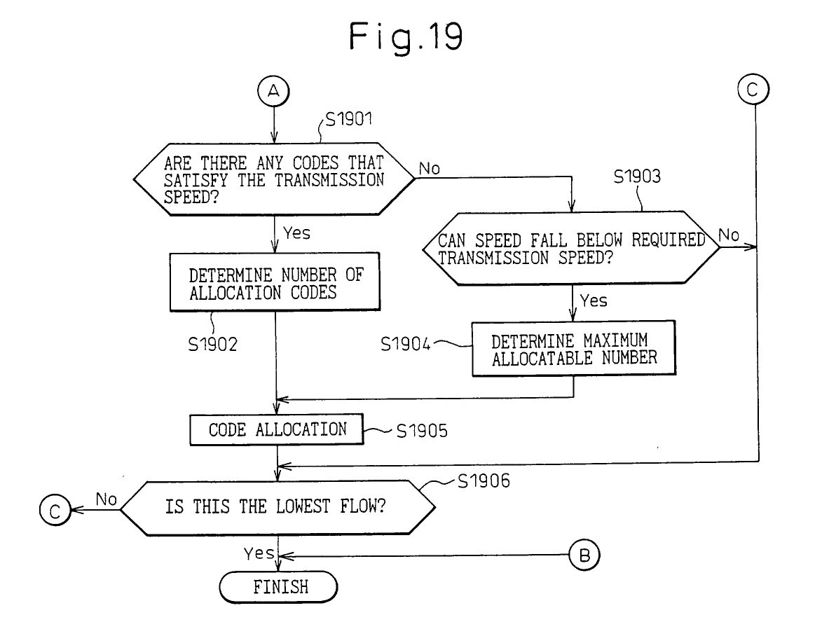

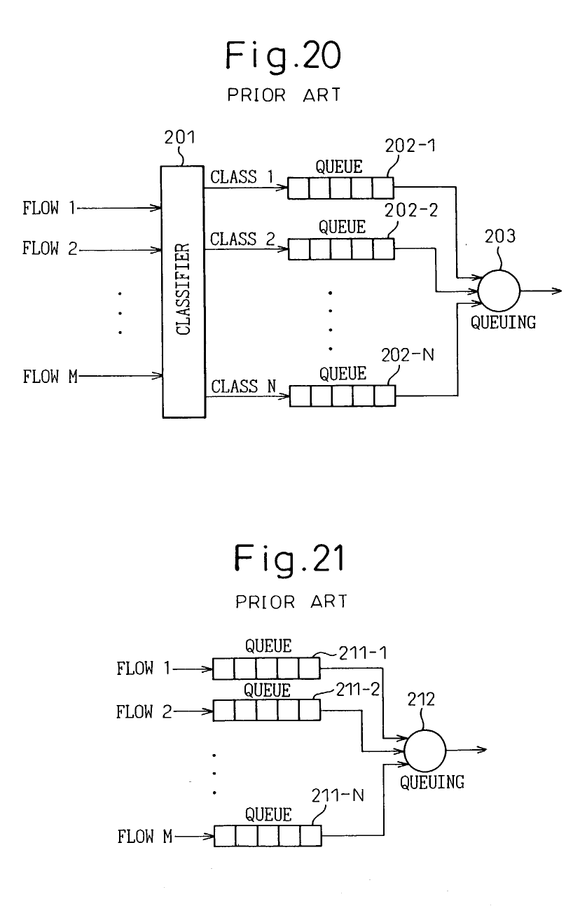

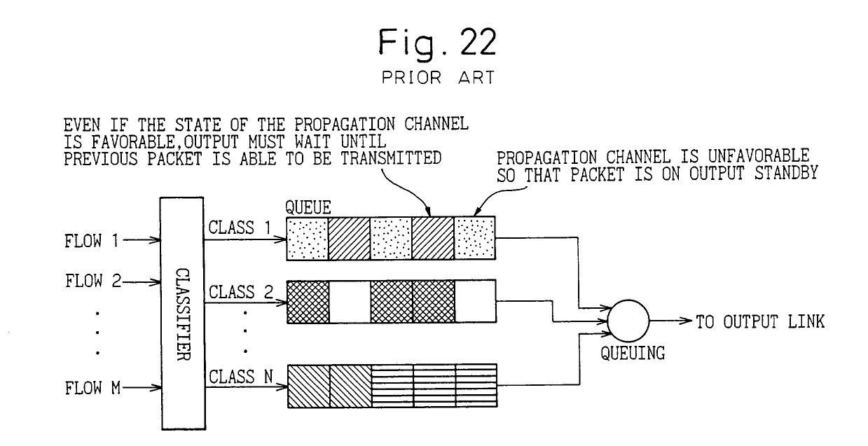

FIG. 18 and FIG. 19 are flow charts illustrating a code allocation process according to a fourteenth embodiment of the present invention.

The difference between FIGS. 18 and 19 and FIG. 14 is the addition in FIG. 18 of steps S1802 to S1808 between steps S1401 and S1402 of FIG. 14.

In other words, as described above, in step S1802 it is determined whether there is a terminal in beam 1, and if so, allocated codes are erased from the list of beam 1, and the lists of beams 2 and 4 that generate significant interference with beam 1 in step S1803.

If the result of step S1802 is no, the process proceeds to step S1804, where it is determined whether there is a terminal in beam 2 and if so, allocated codes are erased in step S1805 from the list of beam 2, and the lists of beams 1 and 3 that generate significant interference with beam 2.

If the result of step S1804 is no, the process proceeds to step S1806, where it is determined whether there is a terminal in beam 3, and if so, allocated codes are erased, in step S1807, from the list of beam 3, and the lists of beams 2 and 4 that generate significant interference with beam 3.

If the result of step S1806 is no, the process proceeds to step S1808, where allocated codes are erased from the list of beam 4, and the lists of beams 1 and 3 that generate significant interference with beam 4.

Thereafter, steps S1809 to S1813 are the same as steps S1403 to S1407 in FIG. 14, and steps S1901 to S1906 in FIG. 19 are the same as steps S1408 to S1413 in FIG. 14, therefore explanation thereof will be omitted here.

Effects of the Invention

As is clear from the above explanation, the scheduling device and scheduling method according to the present invention have the effects of being able to effectively utilize wireless resources expressed by a variety of parameters, realize highly efficient transmission by taking into consideration the state of the propagation channel at the time of resource distribution, and increase the realization of the required quality by a variety of applications. Also, by applying the present invention to beam forming, it has the effect of being able realize a further large increase in capacity.

What is claimed is:

1. A packet transfer scheduling device, comprising
buffering means for storing a plurality of packet flows input in parallel in output standby packet buffers for each of said plurality packet flows;
output priority determining means for determining an output priority order of each packet flow based on packet priority, propagation channel quality and queue length noted by buffer supervising means;
wireless resource estimation means for evaluating allocatable wireless resources; and
wireless resource allocating means for allocating allocatable wireless resources estimated in the wireless resource allocating means to the packet flows stored in the buffering means.

2. The packet transfer scheduling device according to claim 1, wherein, in the buffering means, each of Equation
$$M \cdot \frac{{m}_{0}}{{\sum }_{i = 0}^{N - 1} {m}_{i}} , M \cdot \frac{{m}_{1}}{{\sum }_{i = 0}^{N - 1} {m}_{i}} , … , M \cdot \frac{{m}_{N - 1}}{{\sum }_{i = 0}^{N - 1} {m}_{i}}$$
among buffering memory regions for packet flow buffering are allocated, where a capacity of buffering memory regions for all input packet flows is M bytes, and transmission speeds for each of the packet flows is m₀, m₁, . . . , m_{(N-1)}.

3. The packet transfer scheduling device according to claim 1, wherein the output priority determining means is any one of:
a first priority order determining means for firstly determining output priority according to packet priority, determining priority according to propagation channel quality if there are packet flows with the same output priority, and determining priority according to queue length if there are still packet flows with the same output priority;
a second priority order determining means for firstly determining output priority according to propagation channel quality, determining priority according to queue length if there are packet flows with the same output priority, and determining priority according to packet priority if there are still packet flows with the same output priority;
a third output priority determining means for firstly determining output priority according to queue length, determining priority according to packet priority if there are packet flows with the same output priority, and determining priority according to propagation channel quality if there are still packet flows with the same output priority;
a fourth output priority determining means for firstly determining output priority according to packet priority, determining priority according to queue length if there are packet flows with the same output priority, and determining priority according to propagation channel quality if there are still packet flows with the same output priority;
a fifth output priority determining means for firstly determining output priority according to queue length, determining priority according to propagation channel quality if there are packet flows with the same output priority, and determining priority according to packet priority if there are still packet flows with the same output priority; and
a sixth output priority determining means for firstly determining output priority according to propagation channel quality, determining priority according to packet priority if there are packet flows with the same output priority, and determining priority according to queue length if there are still packet flows with the same output priority.

4. The packet transfer scheduling device according to claim 3, wherein the output priority determining means determines the output priority order by the first output priority determining means while in a basic state, and while supervising the total throughput of input packet flows and the queue length of each packet flow, uses any one of the first output priority determining means to sixth output priority determining means according to the states of the propagation channel and traffic.

5. The packet transfer scheduling device according to claim 3, wherein the output priority determining means is any one of the first output priority determining means to sixth output priority determining means, and a seventh output priority determining means for firstly determining output priority according to packet priority, determining priority according to propagation channel quality if there are packet flows with the same output priority, temporarily giving a packet flow highest priority if its queue length exceeds a fixed value, and again determining priority according to packet priority and propagation channel quality at the next transmission.

6. The packet transfer scheduling device according to claim 3, wherein the output priority determining means is any one of the first output priority determining means to sixth output priority determining means, and an eighth output priority determining means for assigning each of the conditions of packet priority, propagation channel quality and queue length a fixed point and determining priority by the total number of points of each of said conditions.

7. The packet transfer scheduling device according to claim 1, wherein:
the wireless resource estimation means makes wireless resources to be allocated to each packet flow applied to a CDMA system into spreading codes, and examines usable spreading codes; and
the wireless resource allocating means allocates spreading codes of a number that satisfies the transmission speed of each packet flow, from the highest priority order determined by the output priority determining means.

8. The packet transfer scheduling device according to claim 7, wherein the wireless resource estimation means estimates a total transmission speed which a maximum total transmission power does not exceed, from a sum total of the transmission power of each packet flow of a previous transmission and a sum total of the transmission speeds of each packet flow, and according thereto estimates allocatable spreading codes.

9. The packet transfer scheduling device according to claim 7, wherein the wireless resource estimation means applies beam forming, the directions of beams thereof differing, and repetitively allocates the same spreading code to all packet flows having sufficiently small interference between the beams.

10. A packet transmission scheduling method comprising the steps of:
storing a plurality of packet flows input in parallel in output standby packet buffers for each of said plurality of packet flows;
determining an output order priority of each packet flow based on any one of the conditions of packet priority, propagation channel quality, and queue lengths noted by a buffer supervising means;
evaluating allocatable wireless resources based on transmission speed information; and
assigning the estimated allocatable wireless resources to the packet flows stored in the packet buffers.

11. The scheduling method according to claim 10, wherein, in the step of storing the plurality of packet flows in the output standby packet buffers, each of Equation
$$M \cdot \frac{{m}_{0}}{{\sum }_{i = 0}^{N - 1} {m}_{i}} , M \cdot \frac{{m}_{1}}{{\sum }_{i = 0}^{N - 1} {m}_{i}} , … , M \cdot \frac{{m}_{N - 1}}{{\sum }_{i = 0}^{N - 1} {m}_{i}}$$
among buffering memory regions for packet flow buffering are allocated, where a capacity of buffering memory regions for all input packet flows is M bytes, and transmission speeds for each of the packet flows is m₀, m₁, . . . , m_{(N-1)}.

12. The scheduling method according to claim 10, wherein the step of determining output priority order is any one of:
a first priority order determining step of firstly determining output priority according to packet priority, determining priority according to propagation channel quality if there are packet flows with the same output priority, and determining priority according to queue length if there are still packet flows with the same output priority;
a second priority order determining step of firstly determining output priority according to propagation channel quality, determining priority according to queue length if there are packet flows with the same output priority, and determining priority according to packet priority if there are still packet flows with the same output priority;
a third output priority order determining step of firstly determining output priority according to queue length, determining priority according to packet priority if there are packet flows with the same output priority, and determining priority according to propagation channel quality if there are still packet flows with the same output priority;
a fourth output priority order determining step of firstly determining output priority according to packet priority, determining priority according to queue length if there are packet flows with the same output priority, and determining priority according to propagation channel quality if there are still packet flows with the same output priority;
a fifth output priority order determining step of firstly determining output priority according to queue length, determining priority according to propagation channel quality if there are packet flows with the same output priority, and determining priority according to packet priority if there are still packet flows with the same output priority; and
a sixth output priority order determining step of firstly determining output priority according to propagation channel quality, determining priority according to packet priority if there are packet flows with the same output priority, and determining priority according to queue length if there are still packet flows with the same output priority.

13. The scheduling method according to claim 12, wherein the output priority order determining step determines the output priority order by the first output priority order determining step while in a basic state, and while supervising the total throughput of input packet flows and the queue length of each packet flow, uses any one of the first output priority order determining step to sixth output priority order determining step according to the states of the propagation channel and traffic.

14. The scheduling method according to claim 12, wherein the output priority order determining step is any one of the first output priority order determining step to sixth output priority order determining step, and a seventh output priority order determining step of firstly determining output priority according to packet priority, determining priority according to propagation channel quality if there are packet flows with the same output priority, temporarily giving a packet flow highest priority if its queue length exceeds a fixed value, and again determining priority according to packet priority and propagation channel quality at the next transmission.

15. The scheduling method according to claim 12, wherein the output priority order determining step is any one of the first output priority order determining step to sixth output priority order determining step, and an eighth output priority order determining step for assigning each of the conditions of packet priority, propagation channel quality and queue length a fixed point and determining priority by the total number of points of each of said conditions.

16. The scheduling method according to claim 10, wherein:
the wireless resource estimation step makes wireless resources to be allocated to each packet flow applied to a CDMA system into spreading codes, and examines usable spreading codes; and
the step of allocating wireless resources to packet flows stored in the packet buffers is a step of allocating spreading codes of a number that satisfies the transmission speed of each packet flow, from the highest priority order determined by the output priority order determining step.

17. The scheduling method according to claim 16, wherein the wireless resource estimation step estimates a total transmission speed which a maximum total transmission power does not exceed, from a sum total of the transmission power of each packet flow of a previous transmission and a sum total of the transmission speeds of each packet flow, and according thereto estimates allocatable spreading codes.

18. The scheduling means according to claim 16, wherein the wireless resource estimation step applies beam forming, the directions of beams thereof differing, and repetitively allocates the same spreading code to all packet flows having sufficiently small interference between the beams.
